(19) United States
(12) Patent Application Publication
(10) Pub. No.: US 2009/0128980 A1
(43) Pub. Date: May 21, 2009

(54) CIRCUIT ARRANGEMENT FOR CONTROLLING ELECTROMAGNETIC VALVES AND VALVE DEVICE WITH A CONTROLLABLE VALVE

(76) Inventor: Harald KAZMIERCZAK, Beilstein (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/273,671

(22) Filed: Nov. 19, 2008

(30) Foreign Application Priority Data
Nov. 19, 2007 (DE) 10 2007 055 188.8

(51) Int. Cl. H01H 47/00

(52) U.S. Cl. 361/152

(57) ABSTRACT

A circuit arrangement for controlling electromagnetic valves, has a control unit that issues control signals for controlling the angular position of an electromagnetic valve and receives a reply signal regarding the value. The circuit arrangement receives the control signals of the control unit and issues the reply signal to it. A bridge circuit receives control signals from the circuit arrangement for the triggering of a valve servomotor and issues a reply signal, which indicates the angular position of the valve to the circuit arrangement. The circuit arrangement has an angular sensor that transmits a value, which indicates the angular position of the valve to the circuit arrangement. When a rise of the current of the servomotor above a predetermined threshold is detected, the bridge circuit sets a status flag. The circuit arrangement then transmits a predetermined level to the control unit, and the control unit detects the predetermined level. When a level is determined to be impermissible, the control unit requests the value, which indicates the angular position of the valve, from the circuit arrangement and processes this value.

### CROSS-REFERENCE TO RELATED APPLICATIONS

This application is based on German Patent Application No. 10 2007 055 188.8 filed on Nov. 19, 2007, upon which priority is claimed.

### BACKGROUND OF THE INVENTION

1. Field of the Invention

The invention relates to a circuit arrangement for controlling valve systems in vehicles, in particular electromagnetic valves in motor vehicles, by means of an application-specific integrated circuit (ASIC), a valve final control element controlled by this circuit arrangement in a vehicle equipped with at least one controllable valve, and a method for controlling valve systems.

2. Description of the Prior Art

Valve systems in vehicles are usually controlled pneumatically, electropneumatically through the use of rotating magnets, or alternatively, electromagnetically. Known examples include: valve drive units that use an electric motor, in which an H-bridge in the motor control unit controls the motor output and a sensor sends a reply regarding the angular position of the valve; valve drive units that use an electric motor, in which an internal electronic circuit arrangement controls the motor output, the signal of an angular sensor constitutes part of a regulating algorithm, and in this case, settings of valves are learnable; and valve drive units that use an electric motor, in which an internal H-bridge in the motor control unit likewise controls the motor output, with the H-bridge setting a status flag when the current flowing in the motor exceeds a predetermined threshold.

In the latter case, the motor control unit (electronic control unit (ECU)) transmits the desired rotation direction of a valve servomotor by means of a pulse width modulation (PWM) signal. For example, a PWM signal with a keying ratio or duty cycle (DC) of between 10% and 50% means a clockwise rotation of the motor, and a PWM signal with a keying ratio of between 50% and 90% means a counterclockwise rotation of the motor.

In order to trigger the valve servomotor, this PWM signal is either applied for a duration of time that is longer than the time that the motor requires in order to travel from one end position to the other or an increase in the motor current is detected in one of the end positions and when a threshold is exceeded, a status flag is set. This setting signal is then dominant and overwrites the PWM signal output by the motor control unit; this overwriting is in turn detected by the motor control unit and prompts it to react in accordance with its specifications.

In the known arrangement that functions with current detection, however, it is disadvantageous that only an increasing current and finally, an excessive current that exceeds a threshold is detected, which occurs in the motor during normal or regulating operation when the valve being actuated reaches its end position and comes into contact with a stop in the end position.

Such an excessively high current, however, also occurs when the valve being actuated and driven jams in its movement range or when there is a defect in the motor or in the H-bridge in the motor control unit. In this case, the setting of the status flag notifies the motor control unit that the controlled valve has reached its end position and the motor control unit in turn regulates in accordance with its specifications, therefore incorrectly. In order to avoid this, it is therefore necessary to send the motor control unit an error signal that permits the motor control unit to recognize an error state and upon occurrence of such an error state, to react not in accordance with its specifications, but in accordance with the error state.

Previously, the transmission of an error state from the on-site electronics situated within the valve final control element, primarily implemented in the form of an ASIC, to the remotely situated motor control unit required provision of a corresponding signal line, which is disadvantageous and results in higher costs due to the additional complexity and the limited number of pin configurations, i.e. due to a therefore necessary increase in the number of connections in plug connections.

### OBJECT AND SUMMARY OF THE INVENTION

The object of the invention is to create a circuit arrangement for controlling electromagnetic valves, in which it is possible to eliminate an increase in the number of connections in a plug connection, and to create a valve final control element that can be operated with such a circuit arrangement and is equipped with at least one controllable electromagnetic valve.

The invention is based on the concept that through the use of an angular sensor and through a modification of the [missing text] between the motor control unit and the on-site electronics, i.e. the application-specific integrated circuit (ASIC) in the valve final control element, it is possible to transmit the position of the controlled valve to the motor control unit without increasing the number of pins, i.e. the number of connections, in a plug connection.

If the current in the motor rises above a predetermined threshold, then a status flag is correspondingly set. The motor control unit receives this in the form of a level (for example a low level) and, based on a plausibility check, recognizes this to be an impermissible level. After a predetermined time span or waiting period has elapsed, the ASIC circuit in the on-site electronics resets the level to a high-impedance state. After the detection of this altered state, the motor control unit then issues a request in the form, for example, of a PWM signal with a predetermined keying ratio, e.g. 40% to 60%, on the signal line to the on-site electronics. The ASIC circuit in the valve final control element then interprets this request signal as a request for the transmission of the angular position and sends the digital angular value detected by means of the angular sensor back to the motor control unit in a low-dominance fashion, i.e. not overwriting the PWM signal of the motor control unit.

In this way, through the use of fewer signal lines after the setting of the status flag due to an increased motor current, angular position signals are transmitted to the motor control unit and the motor control unit can detect the actual position of the valve based on the respectively transmitted angular position signals and can function in accordance with its specifications, even in the event of an error.

According to a preferred embodiment, the circuit arrangement for controlling electromagnetic valves includes an electronic control unit that issues control signals for controlling the angular position of at least one electromagnetic valve and receives at least one reply signal regarding the angular position of at least one electromagnetic valve. An electronic circuit arrangement communicates with the electronic control unit via at least one signal line, receives control signals of the electronic control unit, and issues at least one reply signal to the electronic control unit. A bridge circuit receives control signals from the electronic circuit arrangement in order to trigger a servomotor for the at least one electromagnetic valve and issues a reply signal, which indicates the position of the at least one electromagnetic valve, to the electronic circuit arrangement. The invention provides that an angular sensor detects the angular position of the electromagnetic valve and transmits a value, which indicates the angular position, to the electronic circuit arrangement. The bridge circuit is designed to set a status flag in the electronic circuit arrangement when the bridge circuit detects a rise in the current of the servomotor above a predetermined threshold. The electronic circuit arrangement is designed to send the electronic control unit a predetermined level via the at least one signal line when the status flag is set in electronic circuit arrangement, and when the electronic control unit detects the predetermined level and determines that the predetermined level is an impermissible level, the electronic control unit is designed to request the value, which indicates the angular position of the electromagnetic valve, from the electronic circuit arrangement and to process this value.

In a preferred embodiment, the electronic circuit arrangement is an application-specific integrated circuit (ASIC) and, embodied in the form of on-site electronics, is situated in a valve final control element.

It is also preferable that the impermissible level is a level that does not correspond to an end position of the electromagnetic valve and in a low-dominance fashion, the electronic circuit arrangement sends the electronic control unit the value, which indicates the angular position of the electromagnetic valve and has been requested by the electronic control unit.

The communication between the electronic control unit and the electronic circuit arrangement is advantageously carried out on the basis of pulse width modulated signals with a respective predetermined keying ratio. A first and second end position of the electromagnetic valve are each associated with a respective first and second keying ratio and a third keying ratio represents a request signal for the electronic circuit arrangement to transmit the value, which indicates the angular position of the electromagnetic valve.

A particularly suitable angular sensor is a contactlessly detecting CMOS Hall sensor that outputs angular values digitally.

Consequently, the invention also relates to a valve final control element, in particular a valve final control element for controlling valve systems in vehicles, in particular motor vehicles, including at least one controllable valve and a circuit arrangement for controlling electromagnetic valves, and additionally relates to a method for controlling electromagnetic valves by the above-mentioned circuit arrangement.

### BRIEF DESCRIPTION OF THE DRAWING

The invention will be better understood and further objects and advantages thereof will become more apparent from the ensuing detailed description of preferred embodiments taken in conjunction with the drawing, in which:

FIG. 1 is a simplified representation of the layout of the circuit arrangement for controlling electromagnetic valves according to an exemplary embodiment.

### DESCRIPTION OF THE PREFERRED EMBODIMENTS

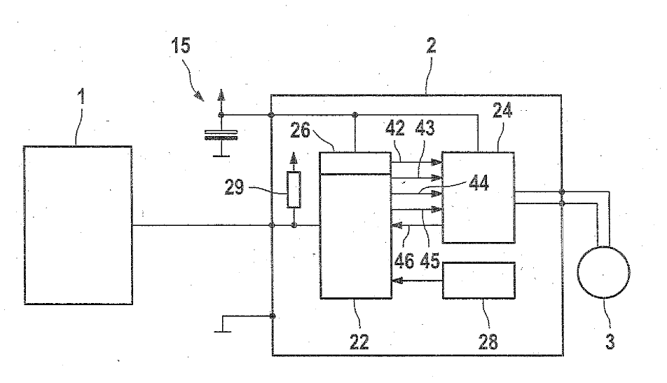

The circuit arrangement for controlling electromagnetic valves shown in a simplified fashion in FIG. 1 includes an electronic control unit or ECU 1, which is for example, a motor control unit in a motor vehicle. The ECU 1 can be situated remote from the motor in almost any location, and also includes a valve final control element 2. The valve final control element 2 is embodied in the form of on-site electronics situated in the final control element, which electronics communicate with the electronic control unit 1 and trigger a motor 3, which can be an electric motor, for example.

The valve final control element 2 is powered with a supply voltage 15 that can, for example, be a battery voltage of a motor vehicle. The valve final control element 2 is provided with an application-specific integrated circuit (ASIC) or ASIC circuit 22, an H-bridge 24 for triggering the motor 3, a voltage converter 26 for supplying the ASIC circuit 22 and H-bridge 24 with an operating voltage, for example 5V, and an angular sensor 28 for detecting the angular position of a valve (not shown) that is actuated by the motor. In addition, a resistor (pull-up resistor) 29 is connected with signal lines between the ASIC circuit 22 and the electronic control unit 1. In the FIGURE, the signal lines between the ASIC circuit 22 and the electronic control unit 1 are depicted in an advantageously simplified fashion in the form of a line. It will be understood that this should be taken as a nonlimiting example and in actual use, a plurality of lines or for example a bus system can connect the ASIC circuit 22 and the electronic control unit 1 to each other, and optionally, a plurality of resistors 29 can be correspondingly provided.

On the one hand, the ASIC circuit 22 is thus connected to and communicates with the electronic control unit 1 via at least one signal line, and on the other hand, it is also connected via various control lines 42 through 45 and at least one reply line 46 to the H-bridge 24 that triggers the motor 3. The control lines 42 through 45 each represent a respective signal input path from the ASIC circuit 22 to the H-bridge 24, whereas the at least one reply line 46 represents a signal input path from the H-bridge 24 to the ASIC circuit 22. The angular detection signal of the angular sensor 28 is likewise routed to the ASIC circuit 22 and in the present example, is embodied in the form of a digital angular detection signal.

The essential functions of the electronic control unit 1, the ASIC circuit 22, the H-bridge 24, the voltage converter 26, the angular sensor 28, the resistor 29, and the motor 3 are each intrinsically dependent on a practical design and are therefore not described in detail. For example, a contactless CMOS Hall sensor of the MLX90316 type (which can be purchased from Melexis, NV Melexis SA, Belgium) can be used as the angular sensor 28.

In particular, the valve final control element 2 in the form of on-site electronics is situated in the final control element itself, triggers the motor 3, which in turn drives the valve (not shown) in an electromotive, electromagnetic, or electromechanical fashion. In this instance, the valve can conceivably be any motor-driven valves or valve systems such as throttle valves in motor vehicles, valves in ventilation systems, and climate control systems, etc.

In a regulating operation, the electronic control unit 1 issues a valve position instruction, for example by means of a PWM signal, which the ASIC circuit 22 converts into a motor triggering command for the motor 3 and prompts the motor 3 to move the valve to be controlled into a desired position, at least to change the valve position for as long as the PWM signal is being issued by the electronic control unit. The H-bridge 24 detects the reaching of an end position of the triggered valve, i.e. when the valve mechanically comes into contact with a stop, by means of a rise in the motor current above a predetermined threshold and sends a reply to the ASIC circuit 22 via the reply line 46. The ASIC circuit 22 sets a status flag in a dominant fashion, as a result of which the PWM trigger signal of the electronic control unit 1 is overwritten and the electronic control unit 1 recognizes that the valve has reached an end position and therefore cancels the PWM triggering signal for the motor 3 and continues its operation in accordance with its specifications.

Such a regulation—in the event of an error in which a valve that jams without reaching its end position or an error in the H-bridge 24 or the motor 3 itself causes the motor current to rise above the threshold—leads the electronic control unit 1 to erroneously assume that the valve to be controlled has reached an end position. An “end position reached” operation sequence in accordance with the specifications, however, is not appropriate in the event of such an error, making it necessary to be able to distinguish such an error ftom the regulating operation.

According to the present exemplary embodiment, the control unit described above is combined for this purpose with an angular sensor and an expanded communication between the electronic control unit 1 and the ASIC circuit 22.

If the current in the motor 3 rises above a predetermined threshold, then, as in the regulating operation, first a status flag (end position reached) is set in the or by the ASIC circuit 22 and is transmitted in the form of a predetermined level (for example a low level) to the electronic control unit 1. Then the electronic control unit 1 recognizes by means of a plausibility check that this is an impermissible level. The plausibility check here is not limited to a certain method or a certain consideration, but can conceivably involve any process that is suitable for determining that an end position of the controlled valve has not yet been or cannot be reached.

After a predetermined time span or waiting period has elapsed, the ASIC circuit 22 resets the level transmitted to the electronic control unit 1 and the associated signal line to a high-impedance state. After the detection of this altered state, the electronic control unit 1 then issues a request in the form, for example, of a PWM signal with a predetermined keying ratio, that differs from keying ratios that indicate end positions of the valve, e.g. by 40% to 60%, to the ASIC circuit 22. The ASIC circuit 22 then interprets this request signal as a request for the transmission of the angular position and sends the digital angular value detected by means of the angular sensor 28 back to the electronic control unit 1 in a low-dominance fashion, i.e. not overwriting the PWM signal of the motor control unit.

Consequently distinguishing between an error state and a regulating operation state requires no additional signal line that would increase the pin configuration density in a plug connection between electronic control unit 1 and the ASIC circuit 22 and instead, through the use of fewer signal lines after the setting of the status flag due to the increased motor current of the electronic control unit 1, angular position signals are transmitted and based on these angular position signals, the electronic control unit can detect the actual position of the valve and function in accordance with its specifications, even in the event of an error.

In addition to being used with individual valves and valve systems, the above-described circuit arrangement can also be used in arrangements of the above-mentioned type in which, upon occurrence of a servomotor current that rises above a threshold, it is necessary to differentiate between a desired regulation and an error, without increasing the number of pins of a plug connection.

The foregoing relates to preferred exemplary embodiments of the invention, it being understood that other variants and embodiments thereof are possible within the spirit and scope of the invention, the latter being defined by the appended claims.

I claim:

1. A circuit arrangement for controlling electromagnetic valves, comprising:
an electronic control unit that issues control signals for controlling an angular position of at least one electromagnetic valve and receives at least one reply signal regarding the angular position of the at least one electromagnetic valve;
an electronic circuit arrangement that communicates with the electronic control unit via at least one signal line, receives the control signals of the electronic control unit, and issues at least one reply signal to the electronic control unit;
a bridge circuit that receives control signals from the electronic circuit arrangement to trigger a servomotor for the at least one electromagnetic valve and issues a reply signal indicating the position of the at least one electromagnetic valve, to the electronic circuit arrangement, the bridge circuit setting a status flag in the electronic circuit arrangement when the bridge circuit detects a rise of current of the servomotor above a predetermined threshold; and
an angular sensor that detects the angular position of the electromagnetic valve and transmits a value, which indicates the angular position, to the electronic circuit arrangement, wherein
the electronic circuit arrangement transmits a predetermined level to the electronic control unit via the at least one signal line when the status flag is set in the electronic circuit arrangement, and when the electronic control unit detects the predetermined level and determines that the predetermined level is all impermissible level, the electronic control unit requests the value, which indicates the angular position of the electromagnetic valve, from the electronic circuit arrangement and processes this value.

2. The circuit arrangement for controlling electromagnetic valves as recited in claim 1, wherein the electronic circuit arrangement is an application-specific integrated circuit and is embodied by on-site electronics and situated in a valve final control element.

3. The circuit arrangement for controlling electromagnetic valves as recited in claim 1, wherein the impermissible level is a level that does not correspond to an end position of the electromagnetic valve.

4. The circuit arrangement for controlling electromagnetic valves as recited in claim 1, wherein the electronic circuit arrangement sends the value, which was requested by the electronic control unit and indicates the angular position of the electromagnetic valve, to the electronic control unit in a low-dominance fashion.

5. The circuit arrangement for controlling electromagnetic valves as recited in claim 1, wherein the communication between the electronic control unit and the electronic circuit arrangement is carried out on the basis of pulse width modulated signals with a respectively predetermined keying ratio.

6. The circuit arrangement for controlling electromagnetic valves as recited in claim 5, wherein a first and second end position of the electromagnetic valve are each associated with a respective first and second keying ratio and a third keying ratio represents a request signal for the electronic circuit arrangement to transmit the value, which indicates the angular position of the electromagnetic valve.

7. The circuit arrangement for controlling electromagnetic valves as recited in claim 1, wherein the angular sensor is a contactlessly detecting CMOS Hall sensor and outputs angular values digitally.

8. A valve final control element including at least one controllable electromagnetic valve and a circuit arrangement for controlling electromagnetic valves, wherein the circuit arrangement is embodied as recited in claim 1.

9. A valve final control element including at least one controllable electromagnetic valve and a circuit arrangement for controlling electromagnetic valves, wherein the circuit arrangement is embodied as recited in claim 2.

10. A valve final control element including at least one controllable electromagnetic valve and a circuit arrangement for controlling electromagnetic valves, wherein the circuit arrangement is embodied as recited in claim 3.

11. A valve final control element including at least one controllable electromagnetic valve and a circuit arrangement for controlling electromagnetic valves, wherein the circuit arrangement is embodied as recited in claim 4.

12. A valve final control element including at least one controllable electromagnetic valve and a circuit arrangement for controlling electromagnetic valves, wherein the circuit arrangement is embodied as recited in claim 5.

13. A valve final control element including at least one controllable electromagnetic valve and a circuit arrangement for controlling electromagnetic valves, wherein the circuit arrangement is embodied as recited in claim 7.

14. The valve final control element as recited in claim 8, wherein the valve final control element controls the angular position of an electromagnetic valve by means of an electric motor.

15. The valve final control element as recited in claim 9, wherein the valve final control element controls the angular position of an electromagnetic valve by means of an electric motor.

16. The valve final control element as recited in claim 10, wherein the valve final control element controls the angular position of an electromagnetic valve by means of an electric motor.

17. The valve final control element as recited in claim 11, wherein the valve final control element controls the angular position of an electromagnetic valve by means of an electric motor.

18. The valve final control element as recited in claim 12, wherein the valve final control element controls the angular position of an electromagnetic valve by means of an electric motor.

19. The valve final control element as recited in claim 13, wherein the valve final control element controls the angular position of an electromagnetic valve by means of an electric motor.

20. A method for controlling electromagnetic valves by means of: an electronic control unit that issues control signals for controlling the angular position of at least one electromagnetic valve and receives at least one reply signal regarding the angular position of the at least one electromagnetic valve; an electronic circuit arrangement that communicates with the electronic control unit via at least one signal line, receives the control signals of the electronic control unit, and issues the at least one reply signal to the electronic control unit; and a bridge circuit that receives control signals from the electronic circuit arrangement for the triggering of a servomotor for the at least one electromagnetic valve and issues a reply signal, which indicates the position of the at least one electromagnetic valve, to the electronic circuit arrangement, comprising the steps of:
detecting the angular position of the electromagnetic valve and transmitting a value, which indicates this detected position, to the electronic circuit arrangement;
setting a status flag in the electronic circuit arrangement when a rise of current of the servomotor above a predetermined threshold is detected;
transmitting a predetermined level to the electronic control unit via the at least one signal line when the status flag is set in the electronic circuit arrangement; and
when the predetermined level is detected and the determination is made that the predetermined level is an impermissible level, requesting the value, which indicates the angular position of the electromagnetic valve, from the electronic circuit arrangement by the electronic control unit and processing of this value.
